(19) United States
(12) Patent Application Publication
(10) Pub. No.: US 2013/0135227 A1
(43) Pub. Date: May 30, 2013

(54) TOUCH SCREEN OPERATION

(71) Applicant: QUALCOMM INNOVATION CENTER, INC., San Diego, CA (US)

(72) Inventor: Chang J. Rhee, San Diego, CA (US)

(73) Assignee: QUALCOMM INNOVATION CENTER, INC., San Diego, CA (US)

(21) Appl. No.: 13/651,501

(22) Filed: Oct. 15, 2012

Related U.S. Application Data
(60) Provisional application No. 61/564,290, filed on Nov. 28, 2011.

(51) Int. Cl. G06F 3/041

(52) U.S. Cl. 345/173

(57) ABSTRACT

A computing device comprising a gesture reception mechanism adapted to accept one or more user gestures and an application. The application is adapted to perform one or more application operations, receive data related to the one or more user gestures, correlate at least one of the one or more application operations to a first of the one or more user gestures, and repeat at least one of the one or more application operations until a second of the one or more user gestures occurs.

### BACKGROUND OF THE INVENTION

1. Field of the Invention

This invention is related to repeating computing device user operations. Specifically, but not intended to limit the invention, embodiments of the invention are related to using a single computer device touch screen operation to scroll through a plurality of user interface content.

2. Relevant Background

Gesture-sensing-enabled computing devices, such as mobile communication devices like smartphones and tablet computers, are capable of running applications that are useful in a variety of contexts (e.g., educational, gaming, financial, and utility applications). Many such devices include sensors and touchscreens which detect a user's actions and relate those actions to user interface operations. Along these lines, applications have been developed that utilize aspects of these sensors and touchscreens.

Through the sensors and touchscreens, these applications enable users to control user interface content. However, existing touchscreen-based techniques for viewing user interface content are often complicated, imprecise, slow, and/or inefficient. As a consequence, the ability to maximize and enhance the user experience for viewing content on a communication device having a touchscreen is not currently being realized.

One such inefficient and slow computing device touchscreen operation may comprise scrolling through computing device content on a touchscreen. For example, a user may be currently required to continue to swipe his or her finger across a touchscreen multiple times in order to access desired content. In one such case, if a computing device folder contains hundreds or even thousands of pictures, a user may be required to swipe a touchscreen dozens of times to reach and display the desired photograph.

### SUMMARY OF THE INVENTION

In order to maximize and enhance the user experience for viewing content on a communication device with a touch screen, and for performing computing device application operations, a system, device, and method were created to easily and quickly repeat computing device application operations using a single user gesture.

One embodiment of such an invention comprises a computing device. Such a computing device comprises a gesture reception mechanism and an application. The gesture reception mechanism may be adapted to accept one or more user gestures. The application may comprise one or more application operations and may be adapted to receive information related to the one or more user gestures. The application may be further adapted to (i) correlate at least one of the one or more application operations to at least one of the one or more user gestures, and (ii) repeat the at least one of the one or more application operations until a second of the one or more user gestures occurs.

Another embodiment of the invention comprises a computing system. One computing system comprises a means for identifying a plurality of user gestures and a means for relating a first of the plurality of user gestures to at least one computing system operation. The computing system further comprises a means for repeating the at least one computing system operation at a first repetition rate and a means for changing the repetition rate when the second of the plurality of user gestures is identified.

And another embodiment of the invention comprises a method of performing a computing device application operation. One such method comprises identifying a first user gesture first movement, the first user gesture first movement comprising a movement in a first direction. The method further comprises activating an application operation and using the gesture reception mechanism to identify a first user gesture second movement in a second direction, the second direction being generally different than the first direction. One method may further comprise repeating the application operation at a repetition rate comprising a first repetition rate. Additionally, the method may comprise using a gesture reception mechanism to identify a first user gesture third movement. Finally, the method may comprise changing the repetition rate of the application operation to a second repetition rate.

Yet another embodiment of the invention comprises a non-transitory, tangible computer readable storage medium encoded with processor readable instructions to perform a method of performing a computing device application operation. One such method comprises initiating a first gesture from a computing device user on a computing device touch screen, correlating the first gesture to a computing device application operation, repeating the computing device application operation, ending the first gesture from the computing device user, and stopping the computing device application operation.

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

### BRIEF DESCRIPTION ON THE DRAWINGS

FIG. 1 illustrates a block diagram depicting components of a computing device;

FIGS. 2A-2C illustrate one or more operations of an application on a computing device; and

FIG. 3 illustrates a flowchart that depicts a method that may be carried out in connection with the embodiments described herein.

### DETAILED DESCRIPTION

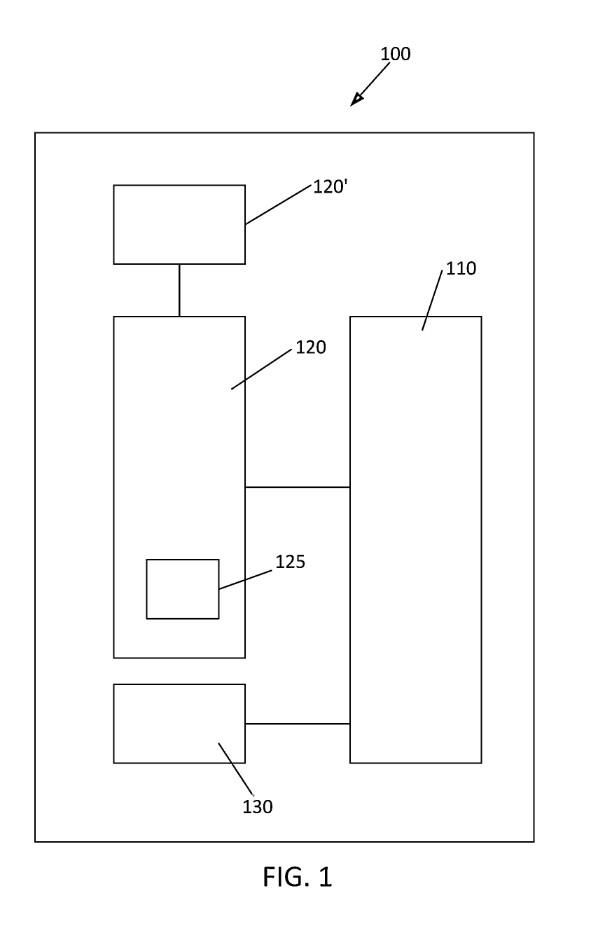

Turning first to FIG. 1, seen is a computing device 100 comprising a gesture reception mechanism 110. The gesture reception mechanism 110 may be adapted to detect one or more user gestures. One gesture reception mechanism may comprise a touch screen. However, other gesture reception mechanisms are also contemplated such as, but not limited to camera or sensor-based gesture reception mechanisms. As also seen in FIG. 1, the computing device 100 in one embodiment comprises an application 120 adapted to perform one or more application operations. One such application 120 may be an internet browser application. However, other applications 120 are also contemplated such, but not limited to, a word processing application or a document viewing application such as, but not limited to, a picture viewing application. Applications 120 may comprise software, hardware, firmware, or a combination of any or all of these items.

One application 120 may comprise one or more application components 125. For example, one application component 125 may comprise a driver adapted to communicate with the gesture reception mechanism 110 or any other portion of the computing device 100. Another application component 125 may comprise a software module adapted to communicate with the driver component. Other application components 125 and component types are contemplated, such as, but not limited to, API application components.

The application 120, potentially through one of the one or more application components 125, may be adapted to receive information related to the one or more user gestures. For example, if the gesture reception mechanism 110 comprises a touchscreen, an application component 125 may receive information related to one or more user gestures on the touchscreen. The application 120 may correlate the one or more user gestures to at least one application operation. It is also contemplated that the application 120 may use information obtained from one or more additional application devices 130 such as, but not limited to, an accelerometer, in correlating the one or more user gestures to the application operation.

Furthermore, it is contemplated that the application component 125 may not comprise a portion of the application 120 but may be accessed by the application. For example, one application component 125 may comprise another application 120′ or firmware residing on the mobile device. In one such embodiment, the another application 120′ may comprise a software module which may be accessed by the application 120 upon the another application 120′ being initiated from a user gesture.

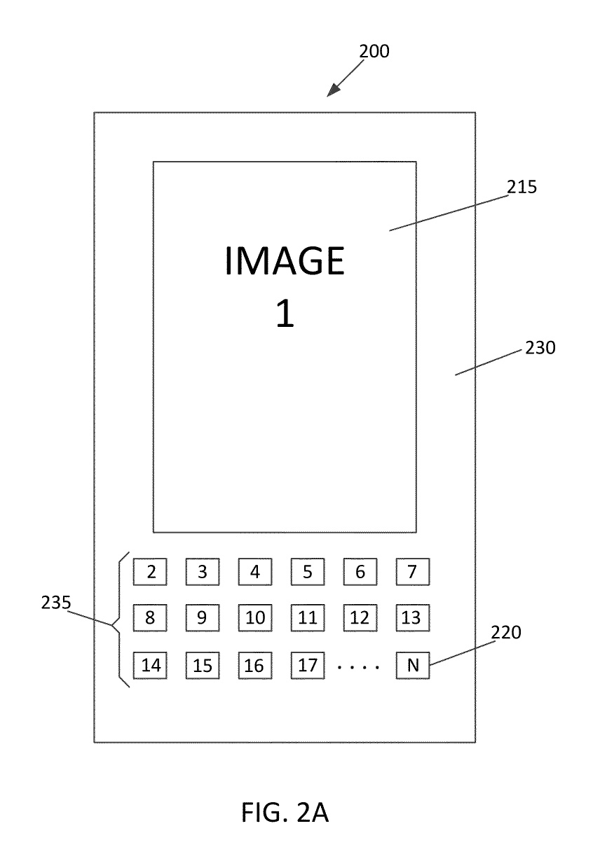

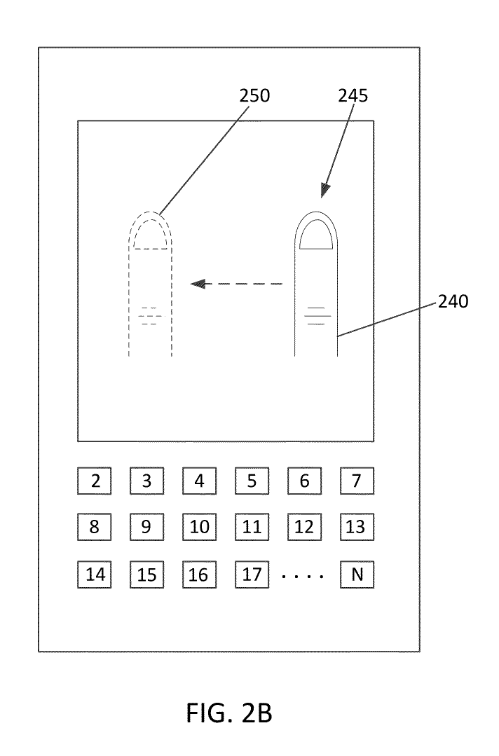

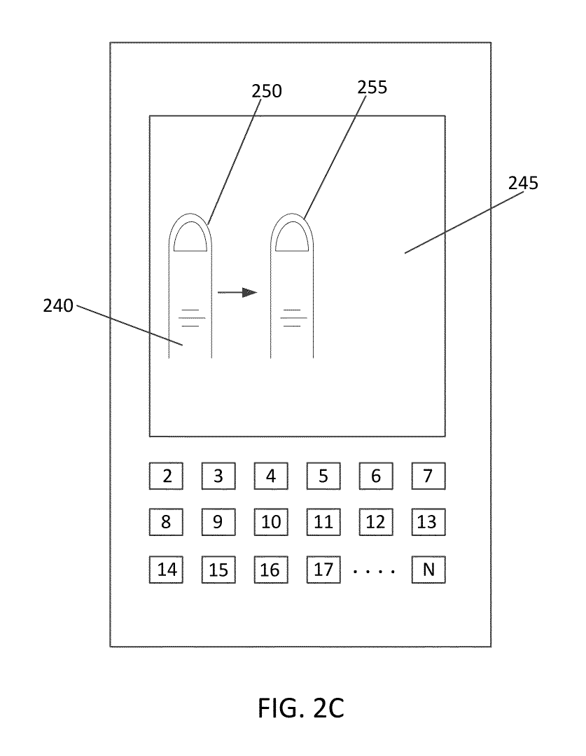

In one embodiment, and as seen in FIGS. 2A-2C one computing device 200 may comprise a touch screen 230 and an application 220 displayed on the touch screen 230. As seen, one such application 220 may be adapted to display an image 215 on the touchscreen 230. One or more thumbnails of additional images 235 adapted to be displayed on the touch screen 230 may also be displayed. Thumbnails numbered 2 through N are shown.

As seen in FIG. 2B, a user may choose to view one of the additional images 235 by scrolling through the images 235. For example, a user may use a touching device 240 such as, but not limited to, a finger to touch the touchscreen 230 at a first location 245. Other touching devices 240 may be used such as, but not limited to, a stylus. Before the touching device 240 is removed from the touchscreen 230, the touching device 240 may travel to a second location 250 by sliding the touching device 240 across the touchscreen 230. In such an embodiment, sliding the touching device 240 in such a manner across the touchscreen 230 may cause the image 215 displayed on the touchscreen 230 to change. For example, as the touching device 240 moves across the touchscreen, each of the additional images 235 may be displayed in an order they may be located in the application 215. For example, image 2 may be displayed before image 3, and so on up to image N.

Therefore, in one embodiment, sliding the touching device 240 on the touchscreen 230 may cause the application 120 to repeat an application operation. In the example seen in FIGS. 2A-2C, the application operation to be repeated may comprise displaying the image 215. Other application operations to be repeated are contemplated.

In one embodiment, touching the touchscreen 230 at the first location 245 and sliding the touching device 240 to the second location 250 may comprise a first user gesture. The touching of the touching device at the first location may comprise a first gesture first movement, and the sliding of the touching device 240 from the first location 245 to the second location 250 may comprise a first gesture second movement. Such a first gesture may cause the application operation to repeat until a second gesture is performed. One second user gesture may comprise removing the touching device from the touchscreen 230. The first and second user gestures may comprise additional movements.

In one embodiment, one of the one or more user gestures or movements may initiate a portion of the application 220 such as, but not limited to, the application component 125. For example, a user gesture which initiates the application component 125 may comprise touching the touchscreen 230 while an application 220 is being displayed (i.e., the first gesture first movement). This may alert the application 220 that upon initiating the first gesture second movement, an application operation may be repeated. One application component 125 may be adapted to repeat a user application operation such as, but not limited to, displaying the image 215 upon sliding a touching device 240 across the touchscreen 230.

In one embodiment, moving the touching device 240 from the first location 245 to the second location 250 may comprise sliding the touching device 240 across the touchscreen 230 in a first direction. One first direction may be a generally horizontal direction from the first location 245 located in a right-side portion of the touchscreen 230 to the second location 250 located in a left-side portion of the touchscreen 230. Other first directions are contemplated such as, but not limited to, a generally upwardly or downwardly vertical direction or otherwise.

In one embodiment, the second direction of the second gesture may comprise a direction substantially perpendicular to, and away from, the touchscreen 230. The second direction may also comprise sliding the touching device 240 in a vertical direction on the touchscreen or in one or more additional or different directions on the touchscreen 230.

In one embodiment, after sliding the touching device 240 from the first location 245 to the second location 250, and, prior to moving the touching device 240 in a second direction which may cease the repeating of the application operation (i.e., the second gesture), the touching device 240 may be slid from the second location 250 substantially back towards the first location 245. Such a movement may comprise a first gesture third movement. For example, turning now to FIG. 2C, seen is a movement of a touching device 240 from the second location to a third location 255 which is between the first location 245 and the second location 250.

In one embodiment, sliding between the first location 245 and the second location 250 and vice versa may also adjust a rate at which the application operation is repeated. For example, seen in FIGS. 2A-2C, upon moving the touching device 240 from the first location 245 to the second location 250, a new image 215 may be displayed every one second. However, moving the touching device back towards the first location 245 from the second location 250 may decrease the rate at which pictures are displayed such that when the third location 255 is reached, a new picture may be displayed every 2 seconds. Other application operation repetition rates are also contemplated. A range of application operation repetition rates may comprise performing thousands of operations per second to performing an operation every 10 seconds or more. In one embodiment where a large number of application operations are needed (i.e., there is a great amount of data to scroll through), some operations may be skipped. For example, if there are 10,000 images to view, moving the touching device from the first location 245 to the second location 250 may display only 1 out of every 100 pictures, but then, in moving the touching device 240 to the third location 255, 1 out of every 20 pictures may be displayed.

In one embodiment, it is contemplated that as the touching device 240 slides between the first and second locations 245, 250, the repetition rate may substantially simultaneously increase or decrease depending on the location of the touching device 240. Additionally, or alternatively, the rate at which the touching device is slid between the first and second locations 245, 250 may correlate to the rate at which the application operation occurs. For example, if the time period it takes for the touching device 240 to slide from the first location 245 to the second location 250 is one second, one image may be displayed every half a second upon reaching the second location 250. However, if the touching device 240 is slid from the first location 245 to the second location 250 in two seconds, one image may be displayed every second upon reaching the second location 250. The rate at which the touching device 240 is moved to the third location 255 may similarly affect the rate that the application operation is repeated. Also, it is contemplated that multiple third locations 255 may be involved as a user slides his or her finger between the first 245 and second locations 250 and different rates, substantially simultaneously speeding up and slowing down the rate of application repetition as the touching device is moved. In one embodiment, the distance between the first and second locations 245, 250 may likewise affect the rate of application operation repetition. Also, a user may perform a second gesture such (e.g., removing the touching device 240 form the touchscreen 230) after one or more first gesture third movements occur. Subsequent to this second gesture, the user may touch and slide the touching device 230 on the touchscreen 230 to once again to change the rate of repetition.

Upon moving the touching device 230 in a direction other than either the first direction or a direction which opposes the first direction, the application operation repetition may be ceased. Such a direction may be referred to as a second direction and may comprise a vertical or diagonal direction on the touchscreen 230, but may also comprise removing the touching device 240 from the touchscreen 230, with the second direction, or the direction of the second gesture in such a case substantially opposing the direction of the first movement of the first gesture.

Throughout the specification and elsewhere, the rate at which the application operation is repeated may be referred to as an application operation rate or just an operation rate or repetition rate. Similarly, when the touching device 230 reaches the second location 250, the operation rate may comprise a first operation rate or repetition rate. Upon reaching the one or more third locations 255, the operation rate may comprise a second operation rate or repetition rate.

The computing device 100 of FIG. 1 may also be referred to as a computing system. One computing system may comprise a means for identifying a plurality of user gestures. One such means may comprise the gesture reception mechanism 110 such as, but not limited to, the touchscreen 230 of FIG. 2. The computing system may further comprise a means for relating a first of the plurality of user gestures to at least one computing system operation. For example, the application 120 may comprise a component 125 that communicates with the gesture reception mechanism 110 to obtain data information related to the user gestures. Such date information may also be obtained from the another application 120′. One system may further comprise a means for repeating at least one computing system operation at a first repetition rate until a second of a plurality of user gestures is identified. For example, as seen in FIGS. 2A-2C, upon sliding the touching device 240 from the first location 245 to the second location 250, the application 230 may continually repeat an operation of displaying a new image 215 on the touchscreen 230 until the touching device 240 is removed from the touchscreen 230. The system may further comprise a means for changing the repetition rate when a second of the plurality of user gestures is identified. For example, one second gesture may include moving the touching device 240 to a third location 255 which may change the rate at which the application operation is repeated.

After reaching the third location 255, one application operation may be repeated at a slower repetition rate as compared to an initial repetition rate. One initial repetition rate may comprise the repetition rate at the second location 250. The slower repetition rate may continue to occur when the second user gesture occurs after the first user gesture, with one second user gesture comprising a gesture in a direction a substantially opposing the direction of a first movement of the first gesture. Similarly, the repetition rate of the application operation may be repeated at a faster repetition rate as compared to the initial repetition rate, with the faster repetition rate occurring when a second user gesture occurs after the second movement of the first user gesture, with the second movement of the first user gesture comprising a gesture in a substantially the same direction as the first gesture second movement.

One embodiment may further comprise a means for activating a portion of the computing system. In such an embodiment, a first movement of the first of the plurality of user gestures may activate a portion of the computing system or device. For example, upon touching the touchscreen 230 with the touching device 240, the system or device 100 may be alerted that a sliding movement of the touching device 240 on the touchscreen may correlate to repeating an application operation. It is also contemplated that a non-sliding touching device 240 movement on the touchscreen 230 may correlate to repeating an application operation. For example, removing the touching device 240 and touching the touchscreen 230 at the second location 250 may cause the application operation to repeat. In one embodiment, the touching device 240 may need to be touched at the second location 250 upon removing the touching device 240 from the first location 245 within a specified time period such as, but not limited to, one second.

Another embodiment may comprise a means for ceasing to repeat the at least one computing system operation. Ceasing of the at least one computing system operation may comprise a third movement of a first user gesture, wherein the third movement may be substantially similar to the second user gesture. When the third movement comprises moving the touching device 230 to the second location 245, the second user gesture may also comprise a first user gesture fourth movement, or greater, depending on the number of third locations 255 involved.

Generally, FIGS. 2A-2C show that, in at least one embodiment, an application 120 or application component 125 may be adapted to modify a user interface display, also known as a user display, with the user display comprising a touchscreen 230 in one embodiment. For example, the user display may be modified by scrolling through one or more modifications of the user interface display, with the modifications comprising displaying images in one embodiment. All other types of modifications known in the art are also contemplated.

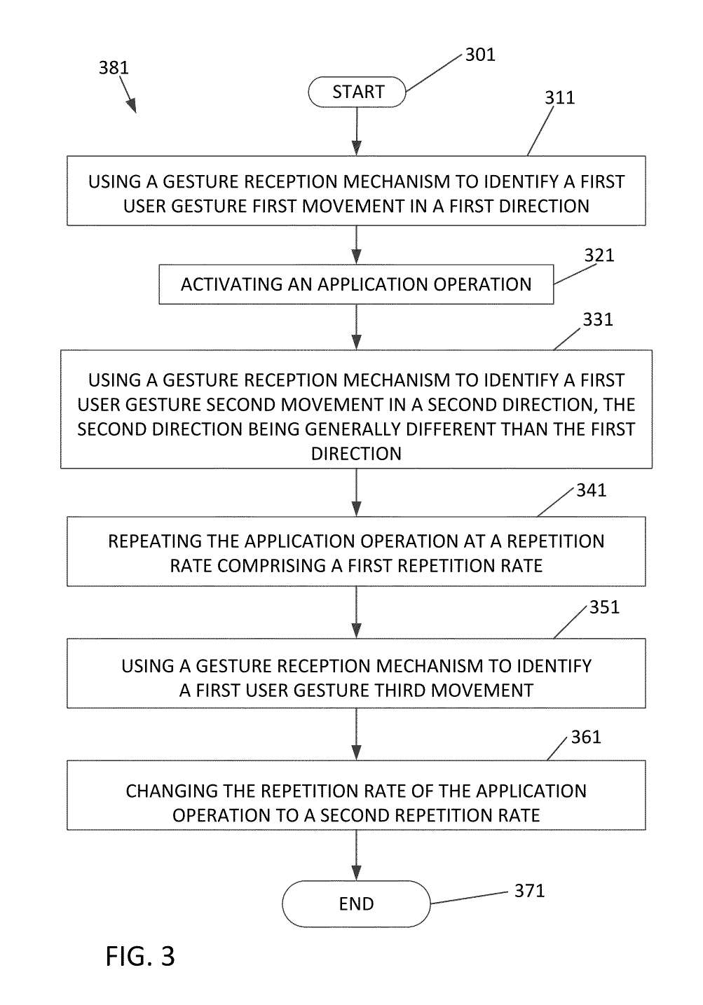

Turning now to FIG. 3, seen is a method 381 of performing a computing device application operation. One such method 381 starts at 301 and at 311 comprises using a gesture reception mechanism to identify a first user gesture first movement in a first direction. Identifying one first movement of a first user gesture with a gesture reception mechanism 110 may comprise using a touchscreen 230 to identify a touching device 240 touching the touchscreen 230 a first location 245. The first direction may be a direction substantially perpendicularly towards the touchscreen 230. At 321 the method 381 comprises activating an application operation. For example, sliding the touching device from the first location 245 to the second location 250 may initiate an application operation of repeating the displaying of an image 215. The application operation may also be activated upon touching the touching device 230 at the first location 245. At 331 one method 381 comprises using the gesture reception mechanism 110 to identify a second movement of the first user gesture in a second direction, the second direction being generally different than the first direction. The second movement may be the sliding of the touching device 230 from the first location 245 to the second location 250. The direction from the first location 245 to the second location 250 may comprise the second direction. At 341 the method 381 comprises repeating the application operation at a repetition rate comprising a first repetition rate. One first repetition rate is related to the distance between the first location 245 and the second location 250. For example, as the touching device 240 moves farther from the first location 245 towards the second location 250, the rate at which the application operation is repeated, is increased. Similarly, the rate at which the touching device 240 is moved from the first position 245 to the second position 250 may also affect the repetition rate, as a quicker move between the two positions 245, 250 may correlate to a faster repetition rate, and vice versa.

At 351 the method 381 comprises using the gesture reception mechanism 110 to identify at least one first user gesture third movement. One third movement may comprise moving the touching device to the third location 255. It is also contemplated that a second gesture which may end the application operation repeating may comprise the third movement. Multiple third movements comprising multiple third locations are contemplated. At 361 the method comprises changing the repetition rate of the application operation to a second repetition rate. For example, when the touching device 240 moves to the third location 255, the second repetition rate may be decreased or increased, depending on whether the third location 255 is located closer to or farther from the first location 245 relative to the second location 250. The method 381 ends at 371.

Although not seen in FIG. 3, one method 381 may further comprise using a gesture reception mechanism 110 to identify a first user gesture fourth movement. One first user gesture fourth movement may comprise a similar movement as the second gesture and may similarly stop the repeating of the application operation. For example, a fourth movement gesture may comprise a movement in a direction substantially opposing the first direction of the first movement of the first user gesture wherein, the touching device 240 may be removed from the touchscreen 230.

The fourth movement and fourth direction occurs when at least one third movement and third direction is involved. For example, when a third location 255 is previously involved in the first gesture, a fourth movement may be used to stop the repetition of the application operation. In such a case, no second gesture may be involved and the first gesture may comprise a single gesture with multiple movements used to start (first movement), modify (second and third movements), and stop (fourth movement) the application operation. When no third location 255 is involved, a third movement may end the application operation repeating by removing the touching device 240 from the touchscreen 230.

In one embodiment, one second movement of a first user gesture may be performed in a second direction at a speed comprising a first movement rate, with the first movement rate corresponding to a first repetition rate of the application operation. As multiple third movements may also occur, the direction and rate of each of the multiple third movements may comprise different movement directions and rates. One third movement direction may oppose the second direction and another third movement direction may be substantially similar to the second movement. When the third direction is substantially similar to the second direction, the speed of the repetition rate may increase and vice versa. It is also contemplated that the speed of each movement may correlate to the speed of the repetition rate, so if the second movement in a second direction over a distance is quicker than the third movement in an opposing third direction over the same distance, the repetition rate may not decrease as much during the third movement as it increase during the second movement.

Another embodiment of the invention may comprise a non-transitory, tangible computer readable storage medium, encoded with processor readable instructions to perform a method of operating a computing device which may also be referred to as a method of performing a computing device operation or application operation. One such embodiment may comprise a portion of the computing device 100 such as, but not limited to information stored on a computing device memory and accessible by a computing device processor. One such method may comprise initiating a first gesture from a computing device user on a computing device touch screen and correlating the first gesture to a computing device application operation. The method may further comprise repeating the computing device application operation, ending the first gesture from the computing device user, and stopping the computing device application operation.

As described above, one embodiment, the first gesture comprises at least one first movement in a first direction. Furthermore, repeating the computing device application operation may comprise repeating the computing device application operation at a first rate. A method may also comprise initiating a second and one or more third movements in a second and one or more third directions, the third direction substantially opposing the second direction and repeating the computing device operation at a second repetition rate, the second repetition rate being slower than the first repetition rate.

In conclusion, embodiments of the present invention provide for the optimized touchscreen operation. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A computing device comprising
a gesture reception mechanism adapted to accept one or more user gestures; and
an application, wherein the application is adapted to,
perform one or more application operations,
receive data related to the one or more user gestures,
correlate at least one of the one or more application operations to a first of the one or more user gestures, and
repeat at least one of the one or more application operations until a second of the one or more user gestures occurs.

2. The computing device of claim 1 wherein, the one or more user gestures is adapted to initiate an application component.

3. The computing device of claim 1 wherein the gesture reception mechanism comprises a touchscreen adapted to identify movement of a touching device.

4. The computing device of claim 1 wherein,
the application is adapted to modify a user interface display; and
the at least one application operation comprises scrolling through one or more modifications of the user interface display.

5. The computing device of claim 1 wherein,
the first of the one or more user gestures comprises moving a touching device from a first location to a second location in one direction; and
the second of the one or more user gestures comprises moving the touching device in another direction different from the one direction.

6. The computing device of claim 5 wherein,
the first of the one or more user gestures comprises a first movement in an first direction;
the one direction comprises a second direction; and
the first of the one or more user gestures comprises moving the touching device to a third location.

7. The computing device of claim 6, wherein,
the one or more application operations are performed at a first operation rate; and
the application is further adapted to one of,
stop the at least one application operation, and
perform the at least one application operation at a second operation rate,
wherein the second operation rate relating to the third location.

8. A computing system comprising,
means for identifying a plurality of user gestures;
means for relating a first of the plurality of user gestures to at least one computing system operation;
means for repeating the at least one computing system operation at a first repetition rate until a second of the plurality of user gestures is identified; and
means for changing the repetition rate when the second of the plurality of user gestures is identified.

9. The computing system of claim 8 wherein,
the first of the plurality of user gestures at least comprises,
a first movement in a first direction, and
a second movement in a second direction; and
changing the repetition rate comprises one of,
repeating the at least one computing system operation at one of a slower repetition rate and a faster repetition rate,
the slower repetition rate occurring when the second of the plurality of user gestures comprises a gesture in a substantially opposing direction as the second direction, and
the faster repetition rate occurring when the second of the plurality of user gestures comprises a gesture in a substantially similar direction as the first direction, and
ending the at least one computing system operation, the at least one computing system operation ending when the second of the plurality of user gestures comprises a direction substantially opposing the first direction.

10. The computing system of claim 8 further comprising, a means for activating a portion of the computing system; and wherein,
the first of the plurality of user gestures comprises two user movements;
the means for activating a portion of the computing system being initiated by a first of the two user movements; and
the first repetition rate of the means for repeating the at least one computing system operation is at least partially determined from a second of the two user movements.

11. The computing system of claim 10 further comprising, a means for ceasing the at least one computing system operation; and wherein,
the ceasing of the at least one computing system operation being related to the second of the plurality of user gestures; and
the second of the plurality of user gesture substantially opposing the first or the two user movements.

12. A method of performing a computing device application operation comprising,
using a gesture reception mechanism to identify a first user gesture first movement, the first user gesture first movement comprising a movement in a first direction;
activating an application operation;
using the gesture reception mechanism to identify a first user gesture second movement in a second direction, the second direction being generally different than the first direction;
repeating the application operation at a repetition rate comprising a first repetition rate;
using a gesture reception mechanism to identify at least one first user gesture third movement in at least one third direction; and
changing the repetition rate of the application operation to a second repetition rate.

13. The method of claim 12, further comprising,
using the gesture reception mechanism to identify a second user gesture; and
stopping the repetition rate of the application operation.

14. The method of claim 13 wherein, the second user gesture comprises a movement in a fourth direction substantially opposing the first direction.

15. The method of claim 12 wherein, the second movement is performed in the second direction at a first movement rate, the first movement rate corresponding to the first repetition rate.

16. The method of claim 15 wherein, third direction comprises,
a substantially similar direction as the second direction; and
at least one of,
at a second movement rate, the second movement rate,
comprising a slower rate than the first movement rate, and
corresponding to a second repetition rate, the second repetition rate being slower than the first repetition rate; and
a third movement rate, the movement third rate,
comprising a faster rate than the first movement rate, and
corresponding to a third repetition rate, the second repetition rate being faster than the first repetition rate.

17. A non-transitory, tangible computer readable storage medium, encoded with processor readable instructions to perform a method of performing a computing device application operation, the method comprising,
initiating a first gesture from a computing device user on a computing device touch screen;
correlating the first gesture to a computing device application operation;
repeating the computing device application operation;
ending the first gesture from the computing device user; and
stopping the computing device application operation.

18. The non-transitory, tangible computer readable storage medium of claim 17, wherein,
the first gesture comprises at least one first movement in a first direction;
repeating the computing device application operation comprises repeating the computing device application operation at a first rate; and further comprising,
initiating one or more second movements in a second direction, the second direction substantially opposing the first direction; and
repeating the computing device operation at a second rate, the second rate being slower than the first rate.

19. The non-transitory, tangible computer readable storage medium of claim 17 wherein,
the first gesture comprises at least one first movement in a first direction at a first movement rate;
repeating the computing device application operation comprises repeating the computing device application at a first repeating rate; and further comprising,
changing the first movement rate to a second movement rate, the second movement rate being greater than the first movement rate; and
changing the first repeating rate to a second repeating rate, the second repeating rate being greater than the first repeating rate.

20. The non-transitory, tangible computer readable storage medium of claim 19 wherein, stopping the computing device application operation comprises removing a finger from a touchscreen.
